(19) United States
(12) Patent Application Publication
(10) Pub. No.: US 2013/0160102 A1
(43) Pub. Date: Jun. 20, 2013

(54) Fully Electronic Notebook (ELN) System And Method

(71) Applicants: Federico Decara, Vaerloese (DK); Thomas Götzsche, Fredensborg (DK)

(72) Inventors: Federico Decara, Vaerloese (DK); Thomas Götzsche, Fredensborg (DK)

(73) Assignee: NOVOZYMES A/S, Bagsvaerd (DK)

(21) Appl. No.: 13/518,307

(22) PCT Filed: Dec. 21, 2010
(86) PCT No.: PCT/EP10/70415

§ 371 Date: Mar. 5, 2013

(30) Foreign Application Priority Data
Dec. 22, 2009 (EP) 09180437.7

(51) Int. Cl. H04L 29/06

(52) U.S. Cl. CPC H04L 63/083
USPC 726/7

(57) ABSTRACT

A system, for record keeping in scientific, industrial, and commercial applications where records are used to document inventions and discoveries, such as in a research laboratory. Such systems are referred to in the applicable field as Electronic Laboratory Notebooks (ELNs). The system deploys data validation and signature validation modules to ensure data integrity and satisfy legal requirements for signature and witnessing documents in a completely paperless environment.

### BACKGROUND OF THE INVENTION

Laboratory notebooks are used daily by scientists and technicians to record hypothesis, experiments, results, information, and interpretations generated by their research. This information or knowledge is traditionally handwritten, and contains experiments and observations as well as the researchers' progress from proposing and testing scientific hypothesis to conceiving and reducing to practice novel inventions and all aspects of research and development in between. The intellectual property contained in such documentation is very valuable and is a highly desirable output of all research efforts.

While the value of this documentation is enormous, the electronic systems for capturing this information have lagged behind modern technology, largely because of the need for very stringent protocols to insure the security and accuracy of the data and the need for documented verification by others. Manually signing a page in a paper notebook is obviously simple. Both the individual making the entry and the witness (i.e. the independent verifying party) provides “wet” signatures to the page or pages on which the information is documented. If a change is made to the document, then the change must also be signed and witnessed.

The manual process for signing and witnessing laboratory notebook pages is legally recognized. However, since it is a paper based system, the records that result from the manual system are cumbersome to archive, review, and recover, if necessary. The security of the manual process is not impregnable. The manual procedure of authenticating each record by printing it, signing it and witnessing it involves a range of risks to an organization because of breakdowns in execution by the involved individuals. Also, the paper system offers no automatic audit trail and depends fundamentally on the diligence and integrity of the individuals involved. However, such procedures are well proven and well implemented.

These security requirements have hampered the development of electronic systems for capturing and archiving research data that has traditionally been recorded in physical laboratory notebooks. This is because any such system must be more secure than the paper alternative. Specifically, in order to substitute the manual procedure, one must offer an alternative procedure for authenticating the records which involves less risk to the organization in terms of data and system integrity. An ideal system will decrease operational risks for the organization, i.e., increase the likelihood that signing and co signing is done correctly, decrease the risk of foul play, etc.

There are other advantages of maintaining the information from laboratory notebooks in electronic form. These include: efficient integration of data from various sources in the lab; better sharing of information among researchers in a team environment; protection of the resulting intellectual property; and the general ease of use and other improvements.

Because of these advantages, Electronic Laboratory Notebooks (ELNs) have been contemplated. Examples of ELNs are described in U.S. Patent Application Publication No. 2007/020880000 entitled “Generic Electronic Notebook” to Frolich et al., International Application entitled, “Process-Linked Data Management System” to Buote et al. and U.S. Patent Application Publication No. 2002/0145742 entitled “Multimedia Laboratory Notebook” to Koenig et al. These systems have offered imperfect solutions to the problems of data security and integrity in an all-electronic environment.

Specifically, while the use of ELNs is now widespread, scientists and their organizations have been unable to entirely substitute traditional methods and paper lab notebooks, due to problems assuring authenticity of the electronic records. For a record to be admissible as evidence e.g., in disputes over rights of invention; the record historically has had to be paper based, signed by the author and witnessed by another scientist, confirming the content of the record as well as the authenticity of it. However, acceptance of digital signatures that meet certain criteria for authenticity and integrity has removed the remaining barrier to using ELNs as the sole medium of storing laboratory notes.

Current ELNs deploy electronic signatures, which themselves are data. That is, the electronic signatures consist of user information and a timestamp stored in a data base and linked to the document to which the electronic signature pertains. In these systems, the ELN signatures have no more integrity than the ELN data itself. Other ELNs deploy a mixture of electronic traces and digital signatures. Such systems require a special editor that controls the content of the ELN. These special editors will identify the author of each entry and add an electronic trace to provide a witnessed document. Generic digital signatures (i.e. digital signatures of the system and not the individual user) are used to seal the electronic signatures into the ELN document. Such systems have significant disadvantages, among them being a lack of compatibility with conventional word processing software platforms. Also, the electronic traces make it extremely complicated to edit the document.

Even though the system requirements for ELN are known, a complete solution must overcome the range of technological hurdles that have not been overcome by the systems described above. In particular, solutions are independent of specific IT systems are sought. This is due to the fact that intellectual property disputes that require access to records regarding the conception and reduction to practice of an invention often occur many years after the records are created. The security of data in documents generated by an ELN must be the same regardless of the software used to create and read the records. This is particularly true of the signatures inserted in the ELN records.

### BRIEF SUMMARY OF THE INVENTION

The Electronic Laboratory Notebook system and method described herein integrates digital signing and witnessing with the creation and updating of records, thus eliminating the risks associated with the manual procedure previously used and other known ELNs. The system combines security with ease of use, thus assuring user compliance. Specifically, the system provides a means of digital signature using the user's standard password (e.g. for users of the Microsoft® Office Software, their “Windows” password), thus simultaneously reducing the risk of fraud and eliminating the need to manage multiple passwords. Although “windows” log on password is expressly identified herein, the ELN systems can be integrated with any log on security feature (i.e. password enabled, finger print enabled, voice activated. etc.). The ELN system and method integrates with the most common office software products that are commercially available, thus making the system easy to deploy and use and requiring little if any special training. In one preferred embodiment, the system inserts a digital signature into the records generated by the ELN. Digital signatures are embedded in the document and are not themselves data (unlike electronic signatures). Mathematical representations (hash value) of the document content include both the signature itself and the particulars of how the signature came to be inserted in the document (e.g. date, system user, etc.) Embedding the electronic signature ensures that the signature is unaltered.

In one embodiment, the system is a web-based system for completely electronic recordkeeping in research and commercial environments. The ELN, in one embodiment, is a collection of data objects from a plurality of data sources using a plurality of data interfaces; a graphical user interface (GUI), wherein the data objects representing laboratory records and/or documentation are organized and approved by users with appropriate and user-friendly security protocols; and a subsystem that enables digital signing, archiving and saving of records, digital witnessing, etc., thus ensuring the integrity, validity, reproducibility and authenticity of the electronic records.

The system authenticates and secures data entered therein from subsequent modification using standard security protocols such as one-way encryption or one-way hashing. Additionally, the system indexes data objects to represent a logical grouping of research activity, and will paginate and archive the date in any desired manner, and can be organized to emulate the organization and pagination of a conventional laboratory notebook.

The system described herein has a signing module that implements a signing procedure. In one embodiment the user is unable to save a record unless that record is first signed, thus assuring that all records are signed. In one embodiment the system provides a signature protocol prompted by a save command.

The signing module also implements a witnessing procedure, by which the witness is selected from a list of embedded criteria such as: i) not a co-inventor or in any way associated with the project to which the document is linked; ii) qualified to meet the criteria of a valid cosigner (i.e. able to read and understand the document); iii) satisfies security protocols for confidential information, etc. In this module, the witness, once selected, is prompted electronically (e.g., by email or sms) to witness the appropriate records. The signing protocol is such that the witness is required to upload for viewing the documents on the witness's GUI for review prior to witnessing. This protocol ensures that records are reviewed by the witness prior to witnessing, and that the witness witness' prior to closing out of the uploaded document. This protocol ensures that records are witnessed correctly.

In the system, the signing functionality for both the signer of the document and the witness allow for use of the individual's regular password that is used to log on to the user's terminal (e.g., desktop, laptop, portable device, etc.) Thus the system does not require the user to learn or remember additional passwords.

The system of recordkeeping can be integrated with any of the currently most commonly used word processing platforms (e.g. Microsoft® Windows®) application, thereby reducing the need for training and the risk that laboratory notes are recorded and stored in other systems.

Integrating a standard word processing platform with a technical infrastructure for handling digital certificates provides many advantages. Specifically, the user can create and edit documents in the standard word processing platform with which they are familiar. When the changes or additions to the document are “checked in” to the ELN, the system captures the user's credentials. In one embodiment, the credentials are encrypted using PKI technology. In this embodiment, when the document is saved to the document server, a message is sent to the server containing a reference to the save document, the user's credential and some metadata that describes the workflow (data entry, save data, etc.). The server then converts the document to a more secure format. In one embodiment that format is a pdf format. The server deploys the users credential to obtain the digital certificate assigned to that user. If the user does not have a digital certificate, or if that certificate has expired, then the system will create or renew the digital certificate from the user credentials and the information available from a lightweight directory access protocol such as, in a Windows environment, the AD {Microsoft acronym for active directory) that provides a variety of network services to the ELN. In a preferred embodiment, the digital certificate is linked to the ELN owner's root certificate, so the system can verify the company for whom the user works.

The system permits the researchers to organize data objects according to organizational criteria, time, protocols, personnel, consumables, or sample identification, as applicable. The system allows all data in the system related to a particular project to be linked among individuals working on the project and stores and archives prior versions of documents in a manner that ensures a historical record of the project is kept, but also ensures that only the most recent version of a multiple version document is revised, and then only by a user with the appropriate security clearance.

The system automatically seeks another user to witness the document. Once the document is created, the system selects an appropriate witness from a list of predetermined criteria. An email is then sent to the selected user. The email contains a link to the document to be witnessed. The system requires that the witness review the email attachment before the witness can insert their signature into the document. Once the user reviews the document, the system prompts the user to authorize the insertion of their signature into the document previously created by the system. The system does not create a new document.

The system and method offers many advantages over prior art ELNs including: i) ease of use in that it is deployed with a current, commercially available word processing platform; ii) employs a standard editor as the document authoring tool; iii) low implementation and maintenance costs; and iv) provides for automatic and timely data capture of the information related to inventive activity.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic of one embodiment of the ELN system of the present invention;

FIG. 2 illustrates the prompt for the domain password;

FIG. 3 illustrates the user certificate linked to the root certificate;

FIG. 4 illustrates the ELN document signed by the author;

FIG. 5 illustrates the ELN document signed by the author and witnessed;

FIG. 6 illustrates the versioned document library;

FIG. 7 illustrates an ELN entry screen for one embodiment of the present invention;

FIG. 8 illustrates an ELN screen displaying a list of experiments from a specific lab notebook for the illustrated embodiment;

FIG. 9 is an ELN screen providing access and status of a specific experiment in the lab notebook;

FIG. 10 is an ELN screen opened to the editor module;

FIG. 11 is an ELN screen of FIG. 10 with a pop up window for the “sign experiment” alert;

FIG. 12 is an email alert to an ELN experiment witness, generated by one embodiment of the present invention;

FIG. 13 is an ELN log on screen for the requested witness;

FIG. 14 is an ELN system workflow for one embodiment of the present invention;

FIG. 15 is the workflow for the electronic signature module of the system in FIG. 14; and

FIG. 16 is the workflow for the electronic witness signature module for the system in

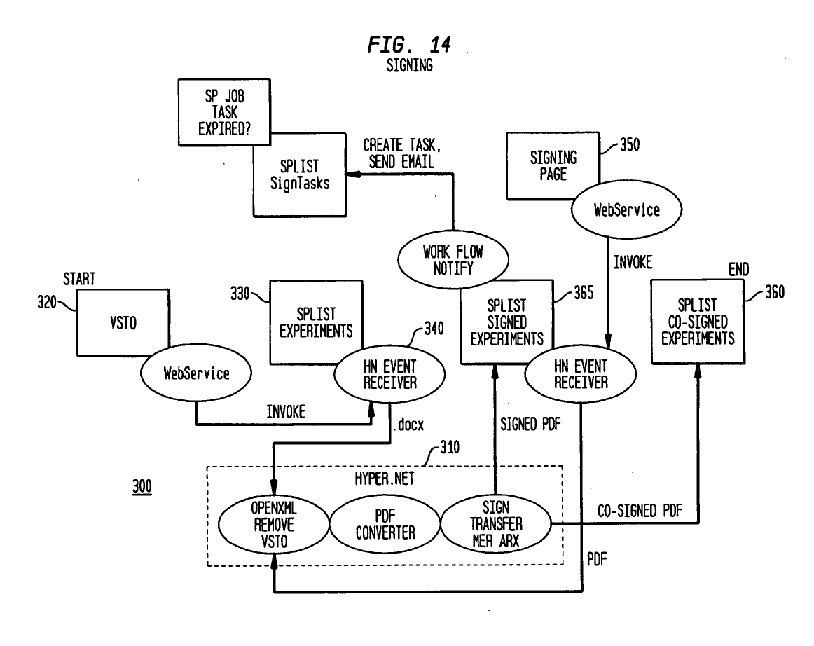

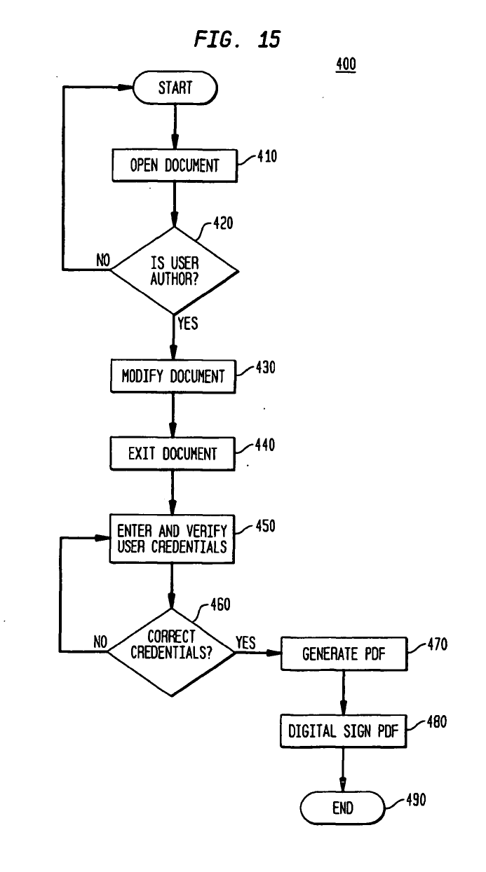

FIG. 14.

### DETAILED DESCRIPTION

The present invention pertains generally to the input and storage of laboratory experiments in a purely electronic form, i.e. an ELN, that satisfies all legal requirements with regard to legally binding signatures and verification and ensures that all entries when “signed” and “witnessed” cannot be altered or at least not altered without detection. More specifically, the present invention relates to systems and methods for capturing and compiling various forms of research data. The system and method also provide modules and protocols, respectively, for signing and witnessing the data entries and storing them in a secure and relatively non-corruptible way that is at least more secure than the compromised security associated with paper records. The system and method provides modules and protocols that document the authenticity of any record, provides searching capability for all records, and ensures data integrity that satisfies all relevant legal, regulatory and scientific requirements. The ELN system and method described herein is a viable substitute for the paper-based laboratory notebooks currently used, in countries that recognize digital signature as a valid means of authorizing electronic documentation.

In one embodiment, the system and method is adapted for use and deployment in a standard word processing software environment (e.g. Microsoft® Word for Windows). The environment in which the system and method are deployed and integrated is referred to herein as the “reference application.” The system is configured such that users must provide their domain credentials (i.e. user ID and password) when adding a record or modifying a record.

This provides an advantage over prior art systems, described above, that require a specialized system that has limited word processing capability along with a local security device (a certificate store such as a USB key) that is a separate device for the user to keep track of and a series of steps for deployment. Furthermore, because authentication and verification of the record occurs in real time as the record is saved, data integrity is both assured and accomplished in a cost effective way.

In a preferred embodiment that saved and verified records are digitally signed documents in PDF format. Therefore the present invention has advantages over prior art systems and methods where the record is created in an unsecured format when accessed as opposed to being archived in a secure format (e.g. pdf) and then accessed by simply being “read.” Again, the system ensures that documents being read are signed, witnessed and in a secure format and documents being edited are only edited when the security protocol has been satisfied.

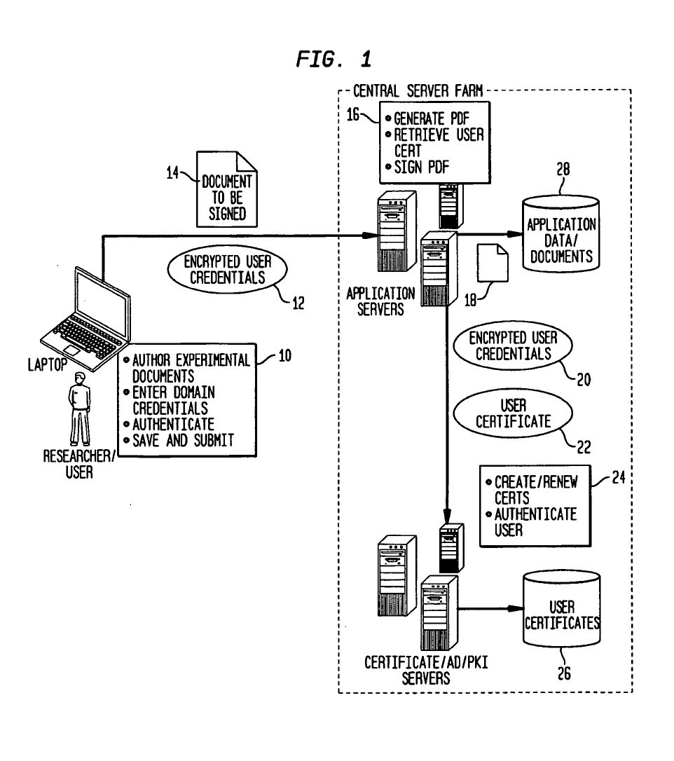

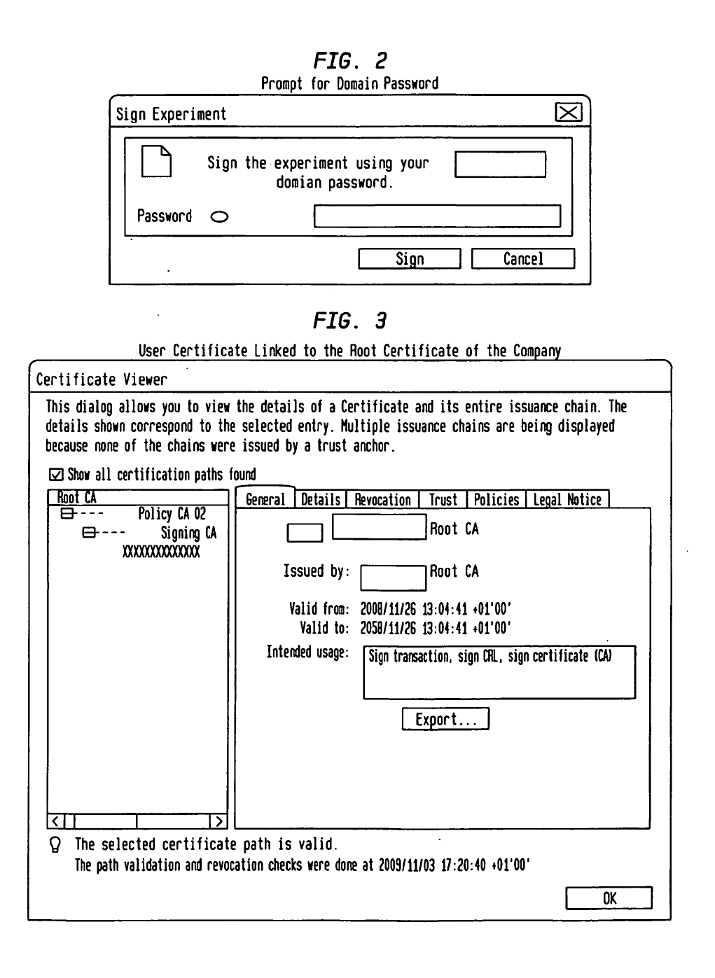

The system and method are described in terms of embodiments with references to the Figures provided. FIG. 1 is a schematic of the system architecture for one embodiment of the present invention. The user interacts with the system via the user terminal 10. The user terminal 10 is illustrated as a laptop, but the skilled person will appreciate that any user interface (e.g. desktop computer, dummy terminal, PDA, etc.) is suited for this purpose. At the user terminal, the user logs on to the system. The system allows the user to work in the standard word processing platform deployed on the user's network. When the user elects to save a document or a change to a document, the system requests the user to enter the user's domain password. The prompt for the domain password is illustrated in FIG. 2. The system then authenticates the user by verifying the user credentials.

The user's credentials are encrypted using PKI technology. PKI technology is well known to one skilled in the art of encryption and is not described in detail herein. In one embodiment that deploys asymmetric cryptography, the encryption uses the public key of a technical certificate. The encrypted credentials are then sent to the server 14 where the document is saved to the server 16. The server generates a file from the document in a more secure format (e.g. a pdf format). The user's credentials are decrypted using the server's private key for asymmetric cryptography. Before the document is stored in memory 28, the user's certificate is retrieved from a central repository with the user's credentials, 20 and 22.

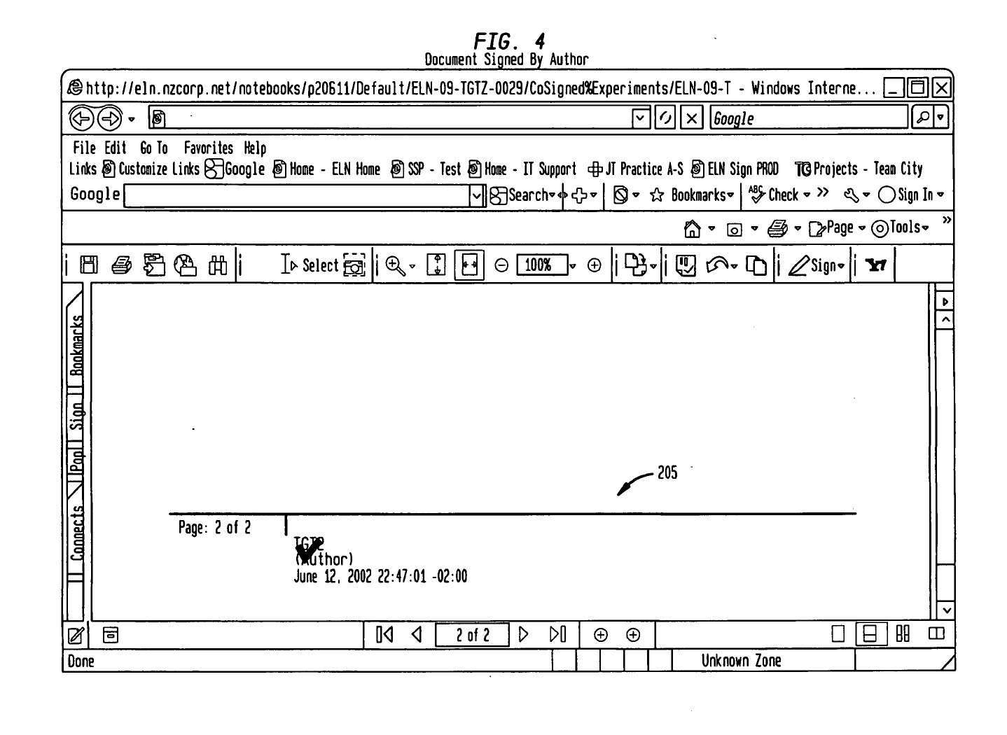

The system populates a signature field inserted in the document with a digital signature created from the user's certificate and the document is created in the desired (e.g. pdf) format. Technology that generates and inserts digital signatures is well known to one skilled in the art and not described in detail herein. One example of commercially available digital signature technology is CoSign by Arx, Inc. located in San Francisco, Calif. The signed document is then stored in memory 28, which is configured as a versioned document library or archive. A module 24 is provided that creates and renews user's certificates. The system does this automatically as part of the verification of user's credentials. Preferably, the certificates are issued with the root of the system owner to verify that the user is an employee or otherwise authorized to make or modify entries to the ELN. User certificates are created, managed and stored in memory 26. This enables all user certificates to be stored centrally and retrieved from a central location. When an employee is terminated, or an authorized user's privileges revoked, the affected certificate will be linked to a table or list that will prevent further use of the certificate. The link between a user certificate and a root certificate is illustrated in FIG. 3. When the user elects to save or exit the system, the user will receive a prompt for entry of the domain password. If the user wishes to save the data entered, the user will enter the password. Once entered the document and the encrypted password are sent to the central server 16 and memory/archive 26 associated therewith. The server converts the document to the desired secure format (e.g. pdf) and inserts the signature in the pdf as described above. The signed document is then stored.

In a preferred embodiment, the ELN is configured so that every addition or change to the ELN from the previous archived version is digitally signed and digitally witnessed.

Furthermore, all versions are archived. The ELN can be defined in any manner desired. The ELN can be all the work of an individual employee (like the conventional paper approach, when a numbered laboratory notebook is issued to each inventor), or can be given an identifier assigned by subject matter or project number. Assigning a common identifier to an ELN assures that all versions are linked in the system.

As noted above, one purpose of an ELN is to document the creation of an invention by one or more ELN entries that are signed, dated and witnessed. In United States patent law, inventive activity must be corroborated by a witness who is not themselves an inventor. A corroborating witness must be capable of reading and understanding the information. The ELN described herein provides documents in pdf form that are signed and witnessed. By providing the documents in pdf (or other) format, the ELN described herein avoids a significant problem of prior art ELNs that generate documents that can only be reviewed by the software system used to generate them. The combination of pdf format and digital signature renders the data sufficiently secure, such that the integrity of the document will not be compromised.

With regard to the mechanisms for saving, signing and witnessing additions and changes to the ELN, two embodiments are described herein. In the first embodiment, which is simpler to implement, signing and witnessing changes to the ELN are done manually at the server level as part of document management. The criteria for instituting the signature and witnessing protocols are determined by the system administrator and are not automatically invoked with every saved change to the ELN. This protocol is less preferred from an evidentiary perspective because the precise date of a specific addition or change cannot be pinpointed. However, this embodiment is very easy to implement because it requires very little modification of the word processing software used to create the ELN documentation.

In a second, preferred embodiment, each saved addition or change to the ELN is signed and witnessed. In this embodiment, each ELN change or addition is saved as a new document. This places a heavy demand on document storage if the ELN is for a project that has a lot of data or continues over a long period of time or has a lot of individuals involved. How the ELN archive is built and how documents are linked in the archive is within the discretion of the ELN owner and is not described in detail herein.

In this embodiment, the word processing platform with which the ELN is integrated is Microsoft® Office Word 2007 that is running in a Windows® environment. The system hooks into the event model of the software so that the exit event (which triggers save changes) can be intercepted. Before the document is closed in the software, the following events occur: i) the document is saved in the ELN storage module 28; the user is prompted for their domain password; and iii) the ELN servers for providing digital signatures are prompted and requested to create and provide a digital signature.

In this embodiment Visual Studio Tools for the Microsoft® Office system 3.0 Runtime (VSTO 3.0) is deployed to extend the capabilities of Microsoft, which is required to run VSTO solutions for the 2007 Microsoft Office system built using Microsoft Visual Studio 2008. In a preferred configuration the electronic signature feature is only activated for certain documents (e.g., only ELN documents and not all documents generated using the software platform). The VSTO tool is attached to the word template that the document is created from. It is contemplated that this baseline template might be used in conjunction with other templates useful for introducing and formatting data into the document.

Although the skilled person is able to integrate the plug in with the desired events in the word processing platform, the following logic is provided as one example of such integration.

private void InternalStartup( )
{
this.BeforeClose += new System.ComponentModel.CancelEventHandler(this.ThisDocument_BeforeClose);
}

In this embodiment, the digital signature reflects the last committed change because the signature protocol is initiated by the BeforeClose event (rather than the BeforeSave event, which might capture changes that are ultimately not saved). The above logic leverages the fact that “Internal Startup” is automatically invoked when Word loads the VSTO 3.0 plug in. The following logic is deployed to ensure that the document is saved before it is sent for processing (i.e. format conversion, signature insertion, etc.). This is achieved by the following command:

Globals.ThisDocumentSave( );

At this point, the ELN prompts the user for credentials (e.g. their domain password). The user's id and domain can be retrieved automatically, since the user is already logged on to the network on which the ELN is deployed. The following logic feeds the userid and domain to the ELN.

userid = Windowsidentity.GetCurrent( ) .Name;
domain = Environment.UserDomainName;

Before the digital signature is inserted, the user is authenticated. The authentication 24 takes place server-side as illustrated in FIG. 1. The following is one example of a suitable authentication protocol:

ntPtr token = IntPtr.Zero;
IntPtr tokenDuplicate = IntPtr.Zero;
If ( LogonUser (username, domain, password, LOGON32_LOGON_INTERACTIVE,LOGON32_PROVIDER_DEFAULT,

ref token) !=0 ) (

if ( DuplicateToken ( token, 2, ref tokenDuplicate ) != 0 ) ({

new WindowsIdentity ( tokenDuplicate ) .Impersonate( );

}

The functions “LogonUser” and “DuplicateToken” are available in Windows dynamic link library (dll advapi32.dll). The “LogonUser” method returns the handle to access the token of the user logging on. In most embodiments the returned handle is the primary token. The primary token has no security information about the client (i.e. the system owner) processes or systems and system owner information is necessary for the impersonation protocol. The call DuplicateToken after LogonUser returns an impersonation token.

In this embodiment, the credentials are encrypted at 12 for transmission. PKI encryption is one suitable example followed by base 64 encoding the encrypted string for transmission in http traffic. This can be accomplished with the following code:

rsa = new RSACryptoServiceProvider ( );
rsa.FromXm1String(publicOnlyKeyXML);
Convert.ToBase64String(rsa.Encrypt(System.Text.Encoding.UTF32.GetBytes(password), false));

The publicOnlyKeyXML is the public key of the PKI certificate used for encryption. A signing server 16 is then invoked to insert the validated signature into the document. The following is one example of logic to invoke the signature:

ServiceHelper.GetSigningServiceClient( ).SignDocument(Globals.ThisDocument.FullName,
WindowsIdentity.GetCurrent( ).Name, encryptedPassword, signReason, signOption, signLocation)

The parameter Globals.ThisDocument.FullName gives a qualified path to the document for signature. The parameter windowsidentity.GetCurrent( ).Name is the logon-id of the current user including the domain. The parameters signReason, signOption, and signLocation are used to provide signing instructions to the signing server. Since the ELN also supports provision of a witness signature, the signing protocol is suited for both authors and witnesses. The ELN documents the role of the signer via the SignReason parameter. The signing field and display format is configured using signOption and signLocation. The system owner can use these parameters to configure the size and placement of the signature (e.g. page, position, etc.).

If the signing process is implemented in the document library 28 instead of the server 16, the signing is invoked manually by the user, or perhaps the next time the user visits the web page where the document library is hosted. The user is still prompted for credentials in this embodiment. In this embodiment, it is preferred if the credentials are protected during transmission from the browser to the server.

The ELN also converts the word document to a different format (e.g. pdf) as illustrated in FIG. 1 at 16. This again occurs on the server side along with authentication of the user and insertion of the user signature in the document. In a preferred embodiment, the word document is converted to a pdf format. This is easily accomplished using the “Save as PDF” add-in provided with Microsoft® Word. Additional code may be required to effect the conversion, and the skilled person is well aware of such code and it is not described herein.

Referring now to the protocol for inserting the signature in the PDF document, in one embodiment CoSign® from Arx (described above) is used along with an application interface (API) called SAPI®. One example of an authentication protocol is:

sapI.Logon(session), user, domain, password);
sapI.CreateSignatureField(pdfFile, p, x, y, height, width);
sapi.SignatureFieldSign(session, signatureField, 0);

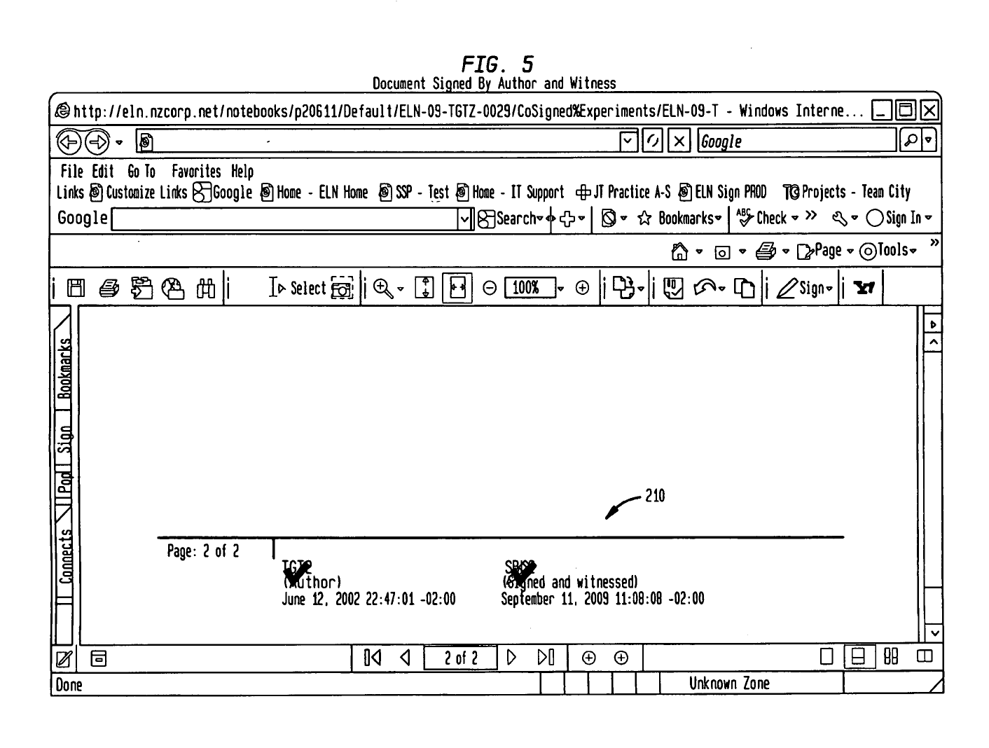

Creation of the signature filed in the PDF document is accomplished by creating code to define the signature field with the required settings regarding page number, position on the page, width and height of the signature field (see lines 10-19 of the code below) and finally the format of the date and time displayed (lines 25-28). The signature field is then inserted into the document according to line 29 of the code. An example of a user signature 205 is illustrated in FIG. 4.

| 1. | public void CreateSignatureField(string filename, int page, int x, int y, int height, int width) | |
|---|---|---|
| | 1. | { |
| | 2. | SAPIib.SigFieldSettingsClass SFS; |
| | 3. | SAPILib.TimeFormatClass TF; |
| | 4. | try |
| | 5. | { |

SFS = new SigFieldSettingsClass( );
TF = new TimeFormatClass ( );

| | |
|---|---|
| 6. | } |
| 7. | catch |
| 8. | { |

throw new Exception (“SAPI COM not registered”);

| 9. | } |
|---|---|
| 10. | SFS.Invisible = 0; |
| 11. | // location: |
| 12. | SFS.Page = page; |
| 13. | SFS.X = x; |
| 14. | SFS.Y = y; |
| 15. | SFS.Height = height; |
| 16. | SFS.Width = width; |
| 17. | // appearance: |
| 18. | SFS.AppearanceMask = 46:// 254; // all (time, name, reason) |
| 19. | SFS.LabelsMask = 0; // no labels |
| 20. | SFS.DependencyMode = |
| | SAPILib.SAPI_ENUM_DEPENDENCY_MODE.SAPI_ENUM_DEPENDENCY_MODE_INDEPENDENT; |
| 21. | SFS.EmptyFieldLabel = “”; |
| 22. | SFS.SignatureType = SAPILib.SAPI_ENUM_SIGNATURE_TYPE.SAPI_ENUM_SIGNATURE_DIGITAL; |
| 23. | SFS.Flags = 0; |
| 24. | // time: |
| 25. | TF.DateFormat = “MMMM d‘, ’yyyy”; |
| 26. | TF.TimeFormat = “HH:mm:ss”; |
| 27. | TF.ExtTimeFormat = |
| | SAPILib.SAPI_ENUM_EXTENDED_TIME_FORMAT.SAPI_ENUM_EXTENDED_TIME_FORMAT_GMT; |
| 28. | SFS.TimeFormat = TF; |
| 29. | int rc = |

SAPI.SignatureFieldCreate(SesHandle, SAPILib.SAPI_ENUM_FILE_TYPE.SAPI_ENUM_FILE_ADOBE,

1. filename, SFS, 0 out sf);

| | |
|---|---|
| 30. | if (rc !=0) |
| 31. | { |

throw new Exception (“Can't create signature field. filename=” + filename +“, rc = ” + rc

| ToString (“X”)); | |
|---|---|
| 32. | } |

As noted above, the ELN provides a module that orchestrates witnessing of the additions and modifications to the ELN largely to comply with legal requirements for independent corroboration of the inventive activity. Consequently, the witness must not be a co-inventor but must be capable of understanding what is being witnessed and actually read what is being witnessed prior to signature. The act of independent corroboration is preferably at least somewhat contemporaneous with the modification or addition to the ELN being witnessed. Preferably all changes and modifications to the ELN are witnessed within thirty days. It is therefore advantageous if the system requires the witness to open the document before the witness can enter their signature as a witness. The witness signature has its own placement in the document but the same commands used to place the user's signature in the document are used to so place the witness signature. An example of a witness signature 210 is illustrated in FIG. 5.

Because the witness signature protocol is advantageously web-based, it is advantageous if the signature application runs in https so that the witness is required to provide a domain password in the web form. Also, because the witness signature is inserted after the user has signed the ELN entry, the signed ELN entry is technically changed. Preferably the ELN archives both the user signed version (FIG. 4) and the witnessed version (FIG. 5). Since each version preferably has a time stamp, the user signed version will have a different time stamp than the user and witness signed versions.

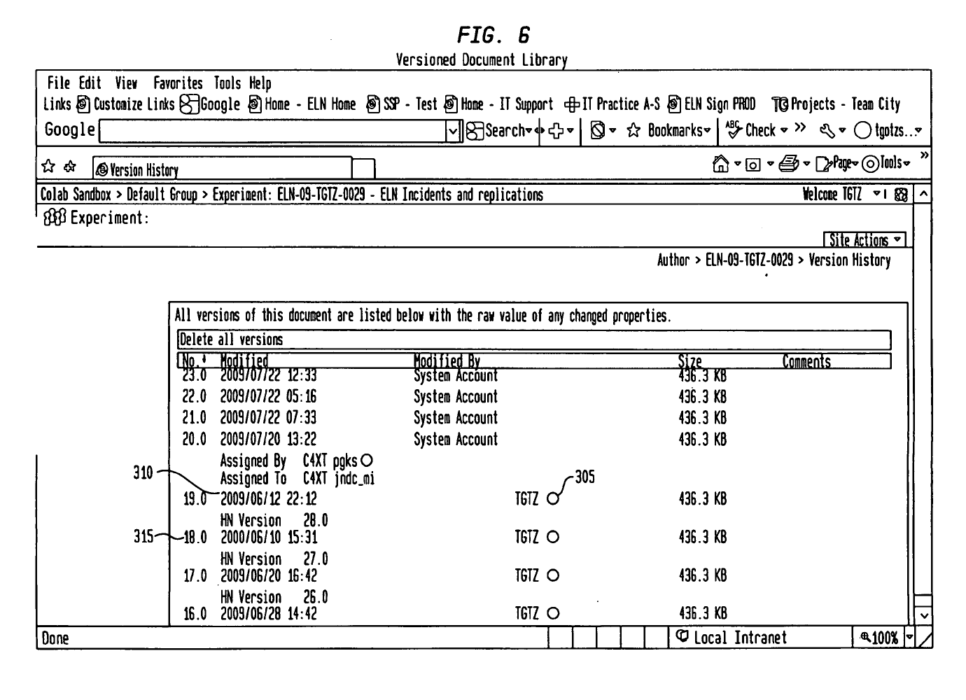

An example of a versioned document library is illustrated in FIG. 6. Note that each version of the document is archived by name 305 and time of entry 310. That time of entry is the time that the changes or modifications were made as described above. The versions are enumerated sequentially 315.

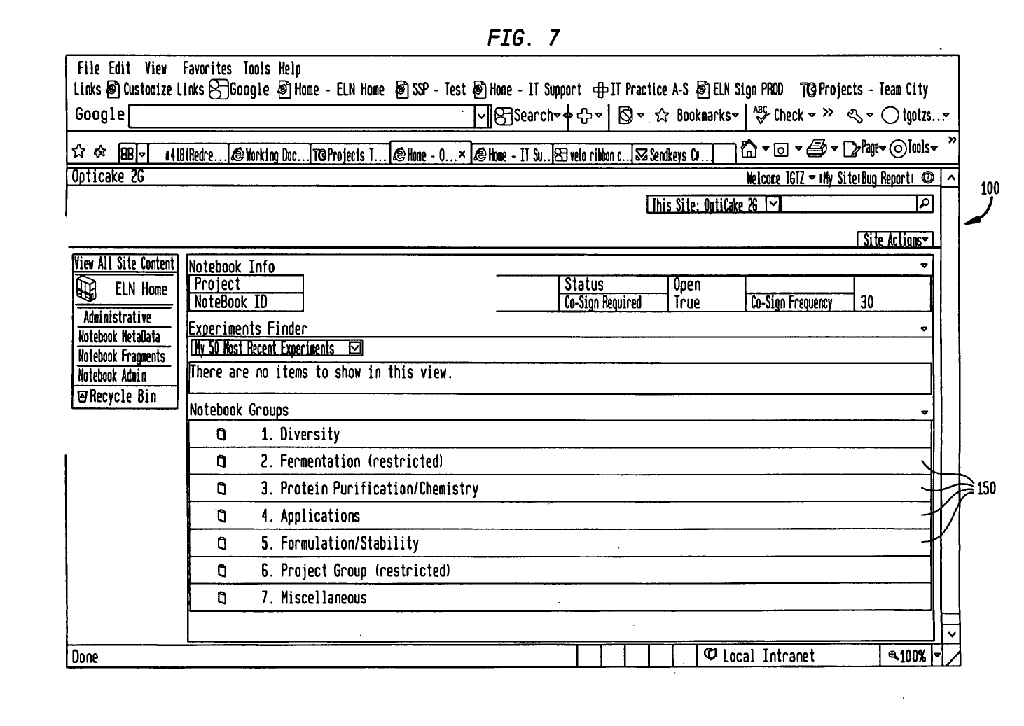

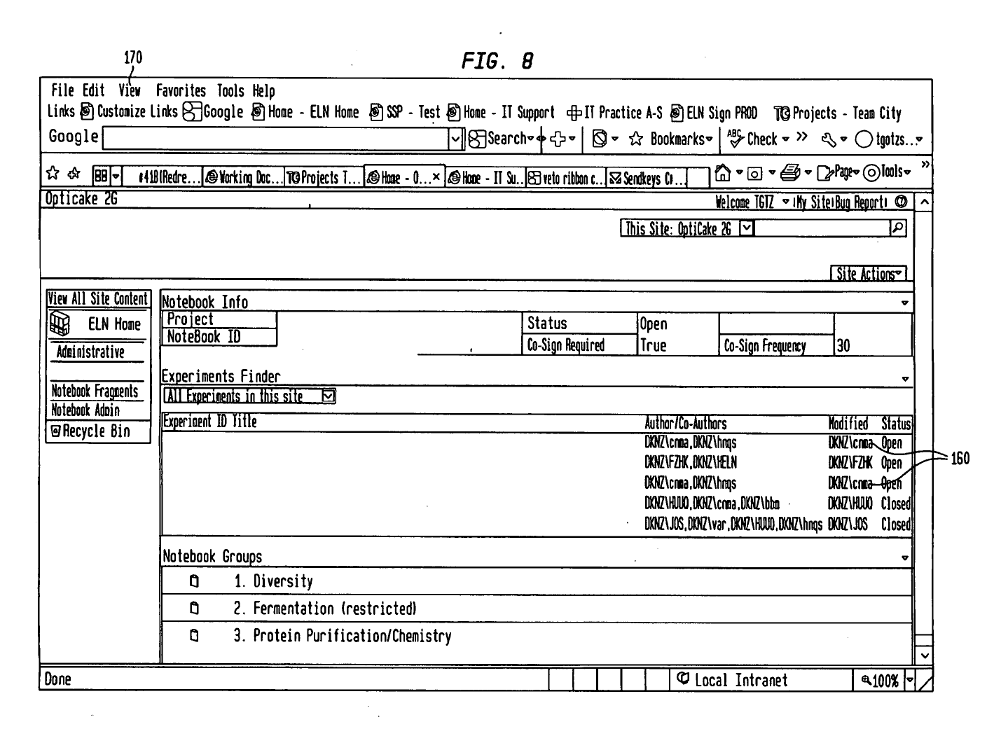

FIG. 7 illustrates the ELN entry screen 100, where all notebooks 110 available to the user can be searched, listed and accessed. Security associated with the user password permits the user to view only those notebooks the user is cleared to access. Additional security protocols such as “read only” or “read and write” can also be implemented. If a specific notebook is chosen (by left clicking the notebook in the list), the user is presented with a list of experiments from the chosen notebook. The experiments are enumerated in the next screen described with reference to FIG. 8. FIG. 8 depicts a list of experiments 160 from a specific lab notebook 150(FIG. 7). By using the “View” drop down menu 170 provided with Microsoft® Word, the user can filter the list, or sort the list, thus displaying a partial list of choice. The user can also choose to go to the experiment overview screen by selecting (i.e. clicking on) a specific experiment 160. The experiment screen is described with reference to FIG. 3.

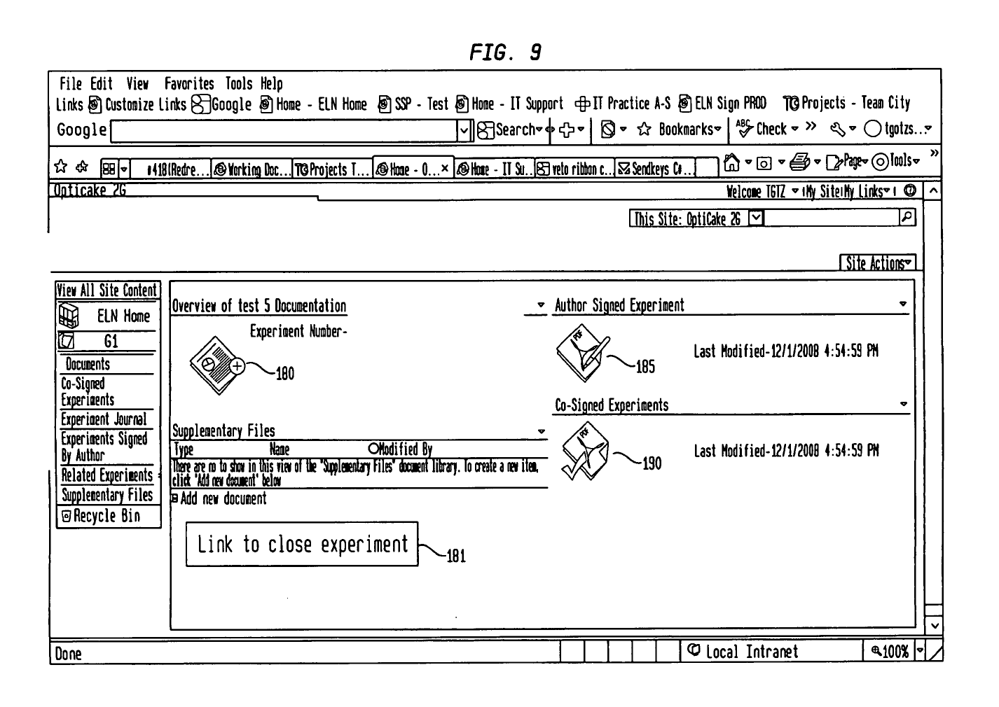

FIG. 9 illustrates a screen shot of the overview of a specific experiment. Here the user can see what documents 180 are linked to this specific experiment. This module sorts the documents between user signed 185 and user-cosigned 190 documents. Selecting the document allows the user to view the respective signatures. Once the document has been co-signed, the system will grant any of the authors the right to close the document to further changes. This is illustrated by the icon 181. Once closed, that document cannot be edited unless reopened by a system administrator. If the document has been cosigned but not closed, any changes to the document will need to be cosigned. The purpose here is document integrity and the system is configured to ensure that a new document, or any changes to an existing document, are signed and witnessed.

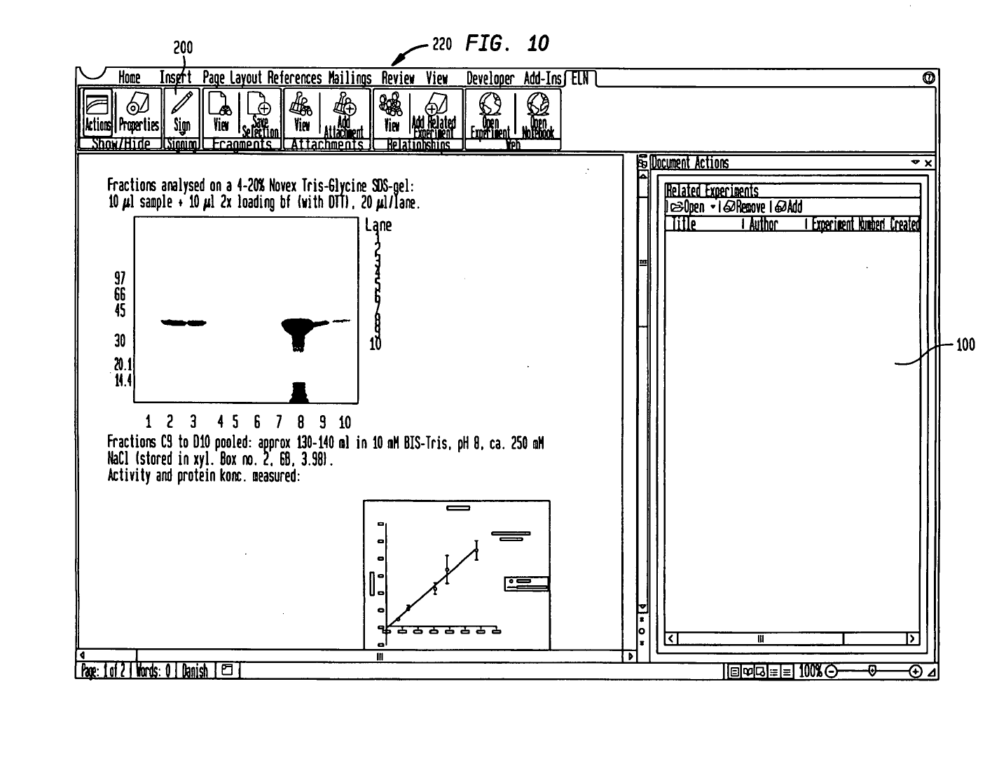

FIG. 10 shows the experiment editor, where the user can edit the experiment documentation (if security clearance permits). The signature module, discussed in detail below, requires the user to sign the document before logging out or closing the document. The user can also selectively enter the signature module by “clicking” the sign button 200 provided in the toolbar at the top of the screen 100.

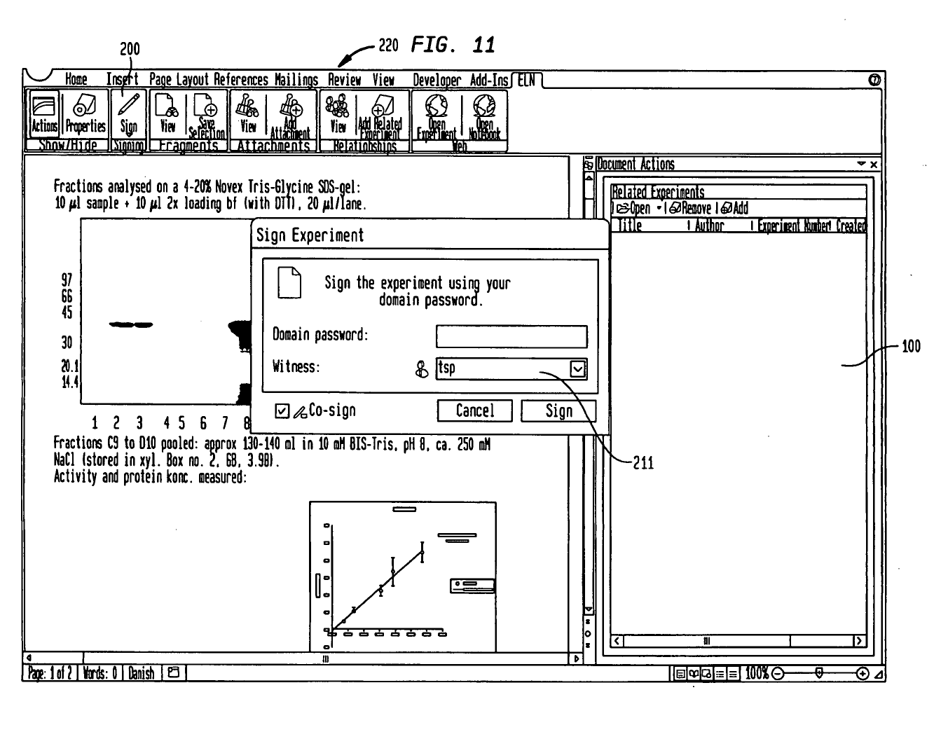

Referring to FIG. 11 the screen 100 with a “Sign Experiment” pop up window 210 is illustrated. The pop-up window 210, as discussed above, is presented to the user if the user either attempts to save changes to an experiment or selects the “sign experiment” button 211 on the toolbar 220. In a preferred embodiment, the user cannot save a change in a document without signature.

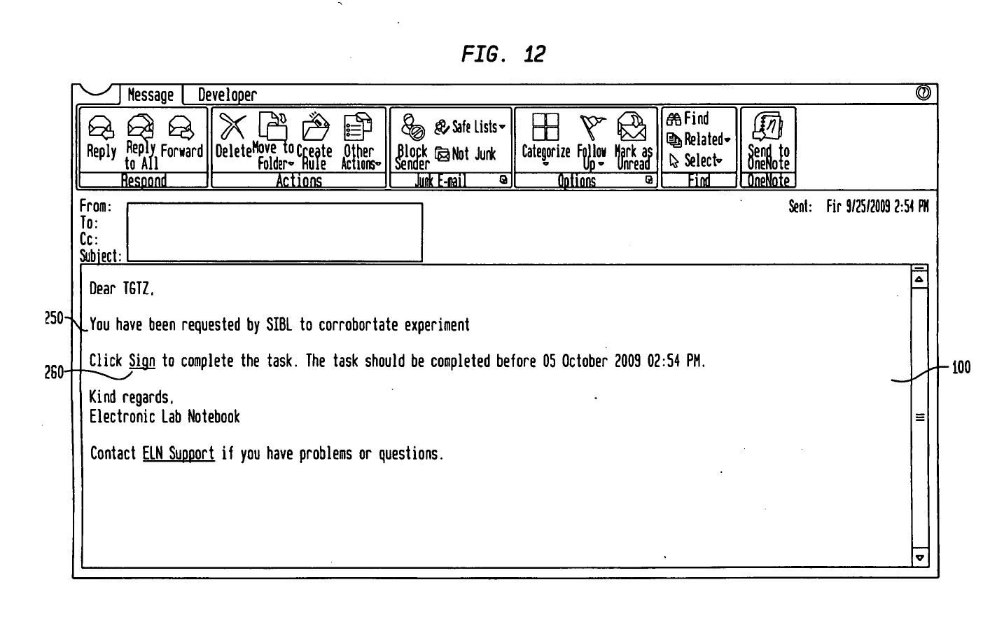

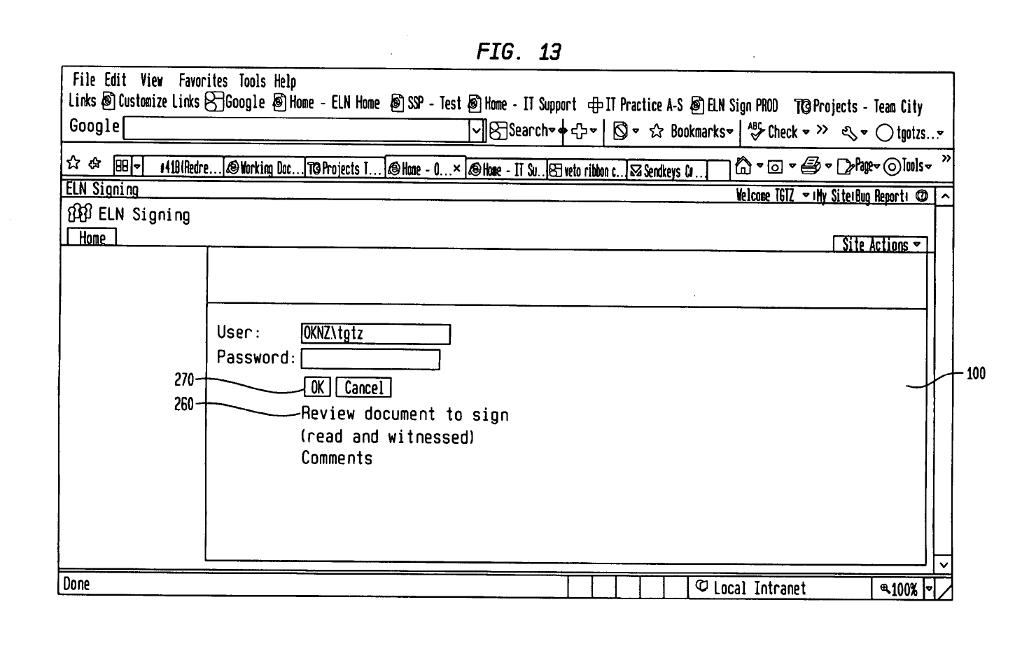

FIG. 12 shows a screen shot of the GUI of a cosigner, when presented with a message 240 that a document needs to be cosigned. The message arrives in the email inbox of the co signer, who has received an email from the system with a live link, reminding him to co sign the experiment. By selecting the link 250, the co signer is presented with the screen shown in FIG. 13, which requires the witness to log on to be able to witness. This feature ensures the integrity and security of the witness signature.

FIG. 14 shows the co signer screen of the witness' GUI terminal. Here, after logging on, the co signer can select the “ok” button 270 to co sign the experiment. The “ok” button is activated if and only if the “Review document to sign” link 260 has been activated, thus assuring that only experiments, which have been presented on screen to the co signer, can be signed.

FIG. 15 illustrates the technical signing workflow of an ELN notebook according to one embodiment of the present invention. The system 300 is equipped with a project management module 310 that generates from documents edited by the use secure (e.g. non-editable; e.g. PDF) files and manages the digital signature protocols for both the user and the witness. The user logs onto the system at 320. This allows the user to view and edit documents if the user is cleared to do so as stated above. When the user elects to save a document or a change to a document at 330, the document is forwarded to the project management module 310 which inserts both the user signature and witness signature into the document and converts the document to a secure format (e.g. a pdf format). Obtaining the signature of the user is through the protocol described above. Once invoked, this protocol selects a valid cosigner from the list of available options and sends an email to obtain the signature of the cosigner. The email includes a link to the document stored in the project management module 310.

Once the cosigner has reviewed the document and entered their electronic signature at 350 that signature is forwarded to the document management module where it is entered into the document. In addition, the fact of the witnessed document is conveyed to the “HN Event Receive 340” that updates the status of the document in the system to a witnessed document. This means that the document can be accessed via the archive for witnessed documents 360. The archive for signed documents that have not been witnessed is 365.

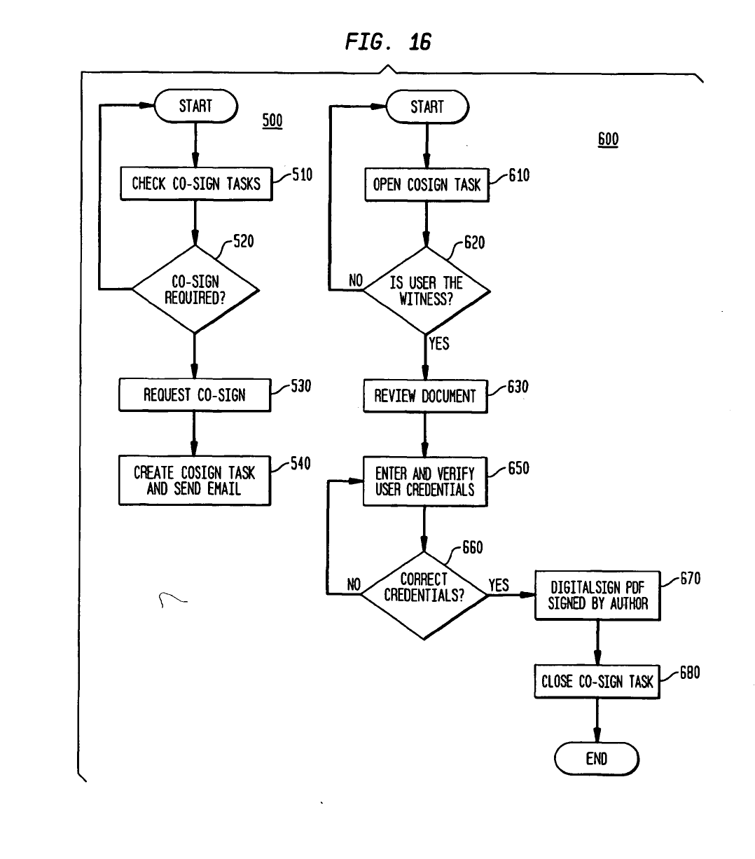

FIG. 16 is a flow chart 400 illustrating the module that ensures every document that is created or changed is signed and turned into a secure document and archived. Specifically, the system allows a user to open a document 410 if the user's credentials are verified and validated 420. The user then works on the document (or creates a new document) 430. When the user is done working on the document, the user will exit, thereby prompting a save and signature protocol 440, 450. If the user's credentials are verified 460, then the system generates a secured version of the saved document (e.g. a pdf) at 470 and executes the digital signature protocol which requires the user to verify the document being saved. In the signature protocol, the system again verifies that the user is authorized to verify and sign the saved document.

FIG. 17 shows the workflow for requesting a witness to corroborate an experiment and the workflow for how the witness performs the task of witnessing the document, which requires both informed review and signature. The witness module creates a task for getting the document witnessed. Specifically, the system first queries for information associated with the document (e.g. the Metadata) that indicates to the system that a witness signature is required 520. If it is, the system initiates the witness signature protocol by generating an automated email to a selected witness. The witness is selected from a list of users in the system that have the qualifications to witness the particular document based upon the information that the system has regarding the document. The automated method of reviewing the data associated with a document to determine the identity of a system user that can serve as a witness is well known to one skilled in the art and not discussed in detail herein.

Once the email is sent to the witness, the witness signature protocol 600 is initiated. Referring again to FIG. 10, the user receives and opens the email 610 notifying the witness that their services are required to witness a document or entry in the ELN. The email requires that the witness verify their identity at 620 to prove to the system that the user is the actual witness that the system has designated via a log on protocol as described above. The log on protocol merely requires entry of the witness's user password. The protocol 600 requires that the witness review the document 630. The system then prompts the witness to enter their credentials, 650, which the system then verifies 660. Once verified, the witness signature is entered onto the document in secure format 670. The witness signature module is then closed. The system therefore manages the entire document life cycle, from its creation to its close. As noted above, the authors determine when to close a document or an entire family of documents (e.g. an experiment or a notebook of documents). Once the author closes a document, it can only be reopened to further changes by an administrator. If an author wishes to make further changes to a document after those changes have been witnesses, the author can elect not to close the document, which can be edited. However, even if the document is not closed, any changes to the document that are made after it has been signed and co-signed will also need to be signed and co-signed.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An ELN comprising:
a document management module deployed on a computer network with a plurality of users, each user being required to log in to the computer network via an assigned password, the document management module having an input for receiving documents from authorized users via a signature verification protocol and processor for converting those documents from a user-editable format to a more secure format as part of the signature verification protocol, the document management module also having an input that communicates with a witness signature module to get the witness to sign the document converted to a more secure format;
a user signature module initiated by saving information to the ELN, wherein the user signature module requires a user to log on using their network password when the user saves the information to the ELN, and wherein the user signature module verifies the identity of the user based upon user information stored in the network, the user signature module inserting the digital user signature in the document saved in a more secure format in the document management module; and
a witness signature module having a processor and memory that identifies a witness for the document based on information about the author of the document and that communicates with the identified witness with an input from the document management module that the document saved in a more secure format requires a witness signature and, once received identifies a witness and sends an email notice to the witness that requires identity verification from the witness before opening and witnessing the document; wherein the witness signature module communicates with the document management module to insert a witness signature on the document saved in a more secure format after witness verification of the document.

2. A method for signing an electronic document comprising:
receiving a prompt from user terminal that a document created or edited is ready to be saved;
prompting the user for domain information to verify the identity of the user;
encrypting the user domain credentials and transmitting said encrypted credentials to and electronic document and signature management server;
verifying the user identification from the encrypted domain credentials;
applying a digital signature of the user to the document.

3. An ELN comprising:
a network module connected to a plurality of terminals wherein the terminal has conventional word processing software deployed thereon;
an interface between the user terminal and the network module for encrypted communication between the user terminal and the network module; and
wherein the network module is in electronic communication with a document archive and wherein the network module requires user identification when the user saves information to the archive, and wherein the network module inserts an authenticated user digital signature in the saved information upon authentication of the user.
